(19) United States
(12) Patent Application Publication
(10) Pub. No.: US 2024/0397879 A1
(43) Pub. Date: Dec. 5, 2024

(54) PLANTING MAT

(71) Applicant: FISKARS FINLAND OY AB, Espoo (FI)

(72) Inventors: Samuel FEMAL, Espoo (FI); Nicholas VALLO, Milford, NH (US); Heidi SCHULTZ, Espoo (FI)

(21) Appl. No.: 18/328,638

(22) Filed: Jun. 2, 2023

(51) Int. Cl. A01G 9/033

(52) U.S. Cl. CPC A01G 9/033

(57) ABSTRACT

A planting mat, comprising a first layer, a second layer joined to the first layer at least partially by their edges, the first layer and the second layer are foldable and releasably fastened at corners to form a tray, at least one panel for rigidity is arranged between the first layer and the second layer.

### TECHNICAL FIELD

The present invention relates to a planting mat, and more precisely to a planting mat suitable for indoor use.

### BACKGROUND

Planting mats or plant care mats are typically for indoor use to protect the counter or table or floor from the soil and easy to clean afterwards. Conventionally, planting mats are made of a single layer and in some designs gripping adjacent edges at corners enables the edges to lift and form a tray.

One of the disadvantages associated with the known planting mats is that when using sharp tools, such as scissors or a trowel, they might damage the layer by making a puncture hole or a tear. In some cases, the tool might even damage the counter or table underneath the planting mat.

Another disadvantage associated with the known planting mats is the size. Sometimes, a large area is needed to repot, propagate, prune and care for the plant. However, sometimes a smaller planting mat is more suitable for the tasks, when there is not enough workspace available.

### BRIEF DESCRIPTION

An object of the present invention is to provide a planting mat to alleviate at least some of the above disadvantages. The objects of the invention are achieved by a planting mat which is characterized by what is stated in the independent claim. The preferred embodiments of the invention are disclosed in the dependent claims.

The invention is based on the idea of providing the planting mat with a layered construction. The planting mat comprises two outside layers forming a pocket, which houses at least one panel for providing rigidity.

### BRIEF DESCRIPTION OF THE DRAWINGS

In the following the invention will be described in greater detail by means of preferred embodiments with reference to the attached drawings, in which

FIG. 1 shows a top view of a planting mat according to an embodiment of the invention in planar configuration;

FIG. 2 shows the top view of the planting mat of FIG. 1 in a tray configuration when corners of the planting mat are releasably fastened;

FIG. 3 shows a side view of the planting mat of FIG. 2;

FIG. 4 shows a perspective view of the planting mat of FIG. 2;

FIG. 5 shows an exploded view of the planting mat of FIG. 1;

FIG. 6 shows a perspective view of the planting mat in a smaller tray configuration;

FIG. 7 shows a perspective view of the planting mat in a compact storage configuration.

### DETAILED DESCRIPTION

FIG. 1 shows a top view of a planting mat according to an embodiment of the invention. FIG. 1 shows the planting mat in a planar configuration. The planting mat has a first layer 1 which may comprise two longitudinal edges 11 parallel with each other and two transverse edges 12 parallel with each other. The longitudinal edges 11 and the transverse edges 12 may be perpendicular to each other. The longitudinal edges 11 can be longer than transverse edges 12 so the first layer 1 may have a rectangular shape. The longitudinal edge 11 can be for example 90 cm to 100 cm long, and the transverse edge 12 can be for example 55 cm to 60 cm long. However, in some embodiments, the first layer 1 may have a shape other than quadrangle, such as a triangle or 5-10 sided polygon. The first layer 1 can be made of polyurethane glue coated nylon, for example, or some other polymer-based material.

The planting mat has a second layer 2 joined to the first layer 1 at least partially by their edges. In some embodiments, the second layer 2 may be joined to the first layer 1 completely along their edges. The first layer 1 and the second layer 2 may be joined together by gluing, stitching, thermal bonding, or combination thereof. The second layer 2 may be same size as the first layer 1. The second layer 2 may be made of same material as the first layer 1.

The first layer 1 and the second layer 2 are foldable and releasably fastened by a fastener 4 at each corner to form a tray configuration having a base 13 and a frame 14 or side walls 14 surrounding the base 13. In some embodiments, the fasteners 4 can be for example hook and loop fasteners, such as Velcro, or male and female button snap pairs. The planting mat may comprise four male and female button snap pairs, one pair arranged to hold each corner. In another embodiment, the fastener 4 can be a separate clip or bracket gripping the perpendicular edges together.

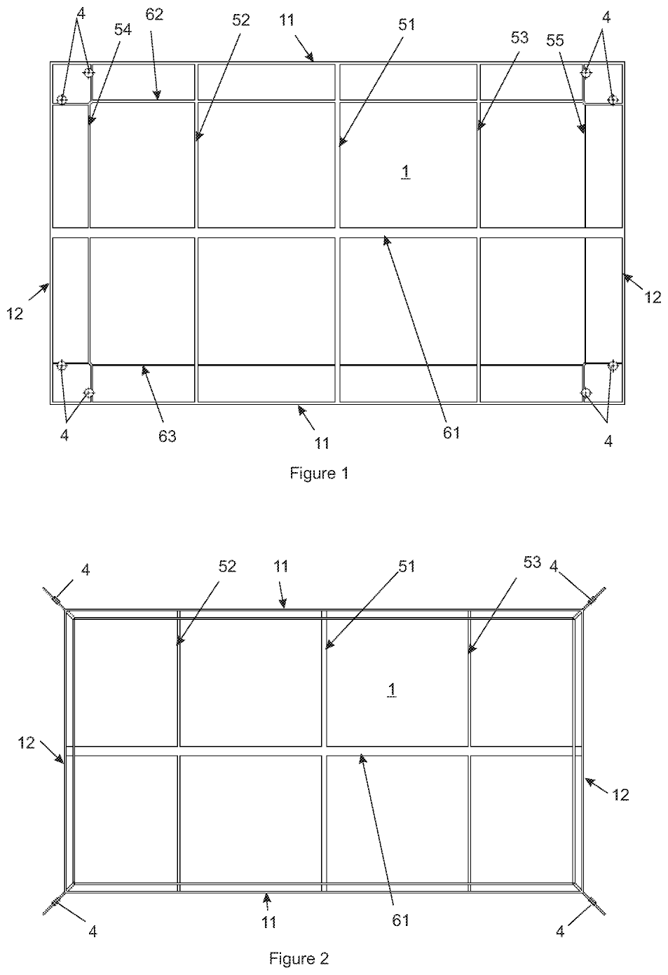

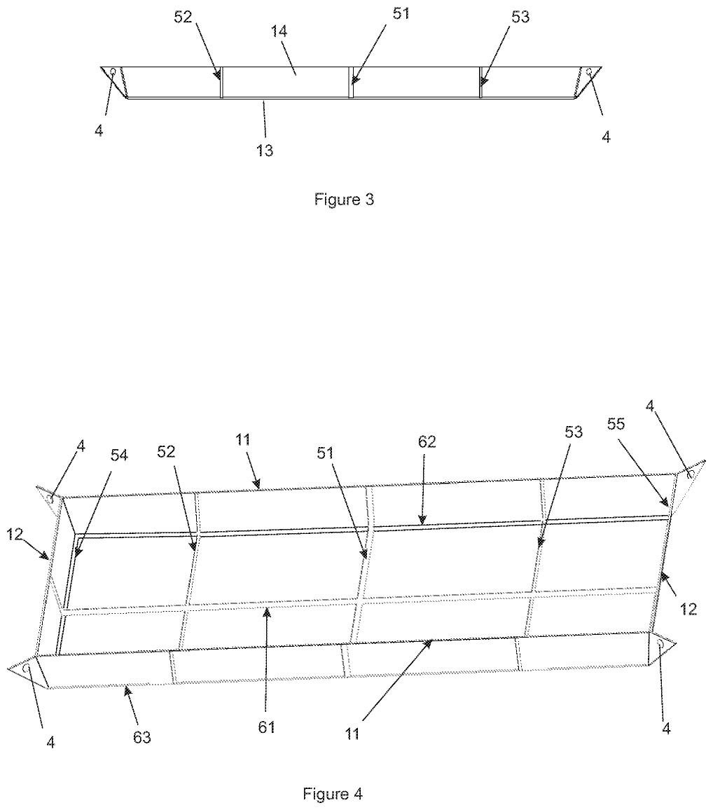

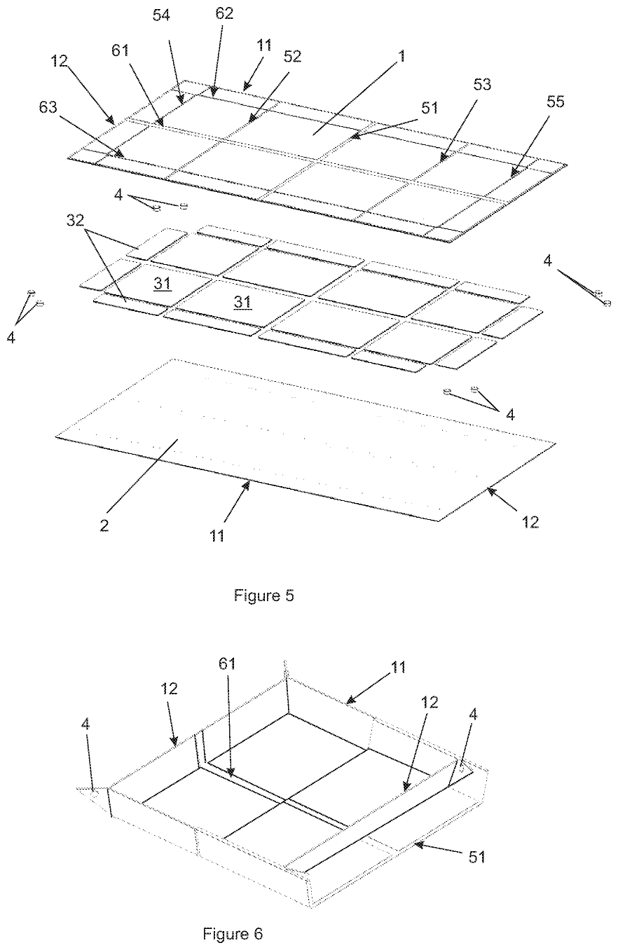

FIG. 2 shows the top view of the planting mat in a tray configuration wherein the corners of the planting mat are releasably fastened allowing the longitudinal edges 11 and the transverse edges 12 to raise. FIG. 3 shows the side view of the planting mat of FIG. 2.

FIG. 4 shows a perspective view of the planting mat of FIG. 2. The planting mat further comprises at least one panel 31, 32 for rigidity arranged between the first layer 1 and the second layer 2. The panels 31, 32 also provide sup-port to the frame 14 of the tray. This prevents the frame 14 to bow outwards. The term “panel” in this context refers to a flat piece of component having enough hard-ness and durability against cuts and slices for protecting the second layer 2. The panels 31, 32 can have a thickness of 0.1 cm to 0.5 cm and be made of polypropylene or other rigid polymeric or polymer-based material. The planting mat may have the second layer 2 joined to the first layer 1 additionally around the perimeters of the panels 31, 32. These attachment regions may also serve as the folding guides for the storage configuration.

At least one of the first layer 1 and the second layer 2 may comprise at least one folding line 51, 52, 53, 54, 55 joining the first layer 1 and the second layer 2 together, wherein the folding line 51, 52, 53, 54, 55 is parallel to the transverse edge 12. A first transverse folding line 51 may be in the middle of the planting mat, dividing the planting mat to two substantially equal areas. A second transverse folding line 52 and a third transverse folding line 53 may be between the first transverse folding line 51 and the transverse edges 12, dividing the planting mat to four areas with the first transverse folding line 51. The four areas may be equal or al-most equal within 5% margin. The first and fourth area closest to the transverse edge 12 may include the height of the transverse frame 14 to fold compactly for storage. The second and third areas closest to the first transverse folding line 51 may include a portion of the longitudinal frame 14. A fourth transverse folding line 54 and a fifth transverse folding line 55 may be located at a distance away from the transverse edges 12. The distance may be 5-10% of the length of the longitudinal edge 11 and may define the height of the frame 14. The height of the frame 14, dependent on the placement of folding lines 54 and 55, are critical to how well the frame 14 stands up, which may also be measured in degrees from horizontal. The frame 14 that is too short will result in different fastener 4 placement, which may cause the frame 14 to bow outwards.

Width of the transverse folding lines 51, 52, 53, 54, 55 may vary. For example, the first transverse folding line 51 may be wider than the second and third transverse folding lines 52, 53. The second and third transverse folding lines 52, 53 may be wider than the fourth and fifth transverse folding lines 54, 55. The first transverse folding line 51 may have a width of 8.5 mm. The second and third transverse folding lines 52, 53 may have a width of 4.5 mm. The fourth and fifth transverse folding lines 54, 55 may have a width of 2.5 mm. However, in some embodiments, the transverse folding lines 51, 52, 53, 54, 55 may have the same width.

At least one of the first layer 1 and the second layer 2 may further, or alternatively, comprise at least one folding line 61, 62, 63 joining the first layer 1 and the second layer 2 together, wherein the folding line 61, 62, 63 is parallel to the longitudinal edge 11. A first longitudinal folding line 61 may be in the middle of the planting mat, dividing the planting mat to two substantially equal areas. A second longitudinal folding line 62 and a third longitudinal folding line 63 may be located at a distance away from the longitudinal edges 11. The distance may be same length as the distance mentioned in the previous paragraph, or it can be 8-13% of the length of the transverse edge 12.

The width of the longitudinal folding lines 61, 62, 63 may vary. For example, the first longitudinal folding line 61 may be wider than the second and third longitudinal folding lines 62, 63. This is due to the thickness of the planting mat increasing as it is folded. The width of the first longitudinal folding line 61 may be equal to or greater than the thickness of the planting mat when it is folded for compact storage. The first longitudinal folding line 61 may have a width of 16.5 mm. The second and third longitudinal folding lines 62, 63 may have a width of 2.5 mm. However, in some embodiments, the longitudinal folding lines 61, 62, 63 may have the same width.

The folding lines 51, 52, 53, 54, 55, 61, 62, 63 may be formed by gluing, stitching, thermal bonding, or combination thereof. The folding line 51, 52, 53, 54, 55, 61, 62, 63 may be sealed in such a way to prevent movement of the panel 31, 32 housed between the first layer 1 and the second layer 2 to cross the folding line 51, 52, 53, 54, 55, 61, 62, 63. The folding lines 51, 52, 53, 54, 55, 61, 62, 63 may join the first layer 1 and the second layer 2 together along the whole length between the longitudinal edges 11 or transverse edges 12 or both.

The folding lines 51, 52, 53, 54, 55, 61, 62, 63 divide the planting mat to areas and each area neighbouring three folding lines 51, 52, 53, 54, 55, 61, 62, 63 or four folding lines 51, 52, 53, 54, 55, 61, 62, 63 may house the panel 31, 32. In the planting mat shown in the accompanying Figures, twenty panels 31, 32 are pro-vided between the first layer 1 and the second layer 2, and each panel 31, 32 is separated from another by one of the folding lines 51, 52, 53, 54, 55, 61, 62, 63. Both longitudinal edges 11 neighbour with four frame panels 32. Both transverse edges 12 neighbour with two frame panels 32. Eight base panels 31 in the middle define the base 13 of the tray, while the twelve frame panels 32 neighbouring the edges define the frame 14 of the tray.

The four base panels 31 next to the first longitudinal folding line 61 and the first transverse folding line 51 may have same size. In some embodiment, they may be substantially square shaped. The two base panels 31 between the second and fourth transverse folding lines 52, 54, and the two base panels 31 between the third and fifth transverse folding lines 53, 55 may have same size, but different than the ones next to the first transverse folding line 51 and may be rectangular shaped.

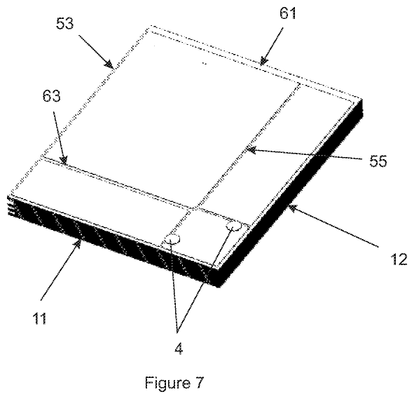

This arrangement allows the base 13 of the planting mat to be folded into a smaller tray configuration and a compact storage configuration. FIG. 6 shows a perspective view of the planting mat in the smaller tray configuration and FIG. 7 shows a perspective view of the planting mat in the compact storage configuration. The middle base panels 31 adjacent to the first transverse folding line 51 may be folded towards each other along the first transverse folding line 51, and the second or third transverse folding lines 52, 53 may be folded in opposite direction than the first folding line 51 by approaching each other. This results in the planting mat having T shaped formation when viewed from the side where the middle base panels 31 are in vertical position. This allows the middle base panels 31 to overlap and be folded under one of the sets of the base panels adjacent to either the second or third transverse folding lines 52, 53, resulting in the smaller tray configuration which is about half the size of the original planting mat.

However, other numbers of the panels 31, 32 with varying sizes may be used. In some embodiments, only one base panel 31 and four frame panels 32 neighbouring the edges 11, 12 may be used. In yet another embodiment, two base panels 31 and six frame panels 32 neighbouring the edges 11, 12 may be used. In yet another embodiment, four base panels 31 and eight frame panels 32 neighbouring the edges 11, 12 may be used. In yet another embodiment, six base panels 31 and ten frame panels 32 neighbouring the edges 11, 12 may be used. In yet another embodiment, only base panels 31 and no frame panels 32 may be used. In yet another embodiment, other than four-sided polygon/geometric shape may be used, such as three-, five-, six-, seven-, eight-, nine- or ten-sided planting mat, wherein the base panels may be triangular shaped. In such embodiments, the number of base panels may correspond to the number of sides. For example, a pentagon has five base panels, and a hexagon has six base panels. The lines between the centre point and the vertices may function as folding lines.

The aim of the present invention is to provide a durable and foldable semi-rigid planting mat having two layers 1, 2 and at least one panel 31 which protect the underneath surface from cuts and punctures. Due to the arrangement of the panels, the planting mat can be folded to a neat and compact size for storage. Further due the arrangements of the panels 31, the planting mat can be folded to a smaller tray configuration when the workspace is limited.

It is to be understood that the above description and the accompanying figures are only intended to illustrate the present invention. It will be obvious to a person skilled in the art that the invention can be varied and modified without de-parting from the scope of the invention.

What is claimed is:

1. A planting mat, comprising:
a first layer,
a second layer joined to the first layer at least partially by their edges,
the first layer and the second layer are foldable and releasably fastened at corners to form a tray,
at least one panel for rigidity is arranged between the first layer and the second layer.

2. The planting mat of claim 1, wherein the first layer comprises two longitudinal edges parallel with each other and two transverse edges parallel with each other.

3. The planting mat of claim 2, wherein the first layer comprises at least one folding line joining the first layer and the second layer together.

4. The planting mat of claim 3, wherein the folding line is parallel to the longitudinal edge.

5. The planting mat of claim 3, wherein the folding line is parallel to the transverse edge.

6. The planting mat according to claim 5, wherein a first transverse folding line is in the middle of the planting mat.

7. The planting mat according to claim 6, wherein a second transverse folding line and a third transverse folding line are between the first transverse folding line and the transverse edges.

8. The planting mat according to claim 7, wherein a fourth transverse folding line and a fifth transverse folding line are located at a distance away from the transverse edges.

9. The planting mat according to claim 4, wherein a first longitudinal folding line is in the middle of the planting mat.

10. The planting mat according to claim 9, wherein a second longitudinal folding line and a third longitudinal folding line are located at a distance away from the longitudinal edges.

11. The planting mat according to claim 3, wherein the planting mat comprises at least one transverse folding line and one longitudinal folding line.

12. The planting mat according to claim 3, wherein the at least one folding line divides the planting mat to areas and each area neighbouring at least three folding lines houses the panel.

13. The planting mat according to claim 1, wherein the first layer and the second layer are made of same material.

14. The planting mat according to claim 1, wherein the first layer is made of polyurethane glue coated nylon.

15. The planting mat according to claim 1, wherein the panel is made of polypropylene.

16. The planting mat according to claim 1, wherein the planting mat comprises four male and female button snap pairs for releasably fastened the corners to form the tray.

17. The planting mat according to claim 1, wherein the planting mat comprises two base panels and six frame panels neighbouring the edges.

18. The planting mat according to claim 1, wherein the planting mat comprises four base panels and eight frame panels neighbouring the edges.

19. The planting mat according to claim 1, wherein the planting mat comprises six base panels and ten frame panels neighbouring the edges.

20. The planting mat according to claim 1, wherein the planting mat comprises eight base panels and twelve frame panels neighbouring the edges.
